(19) United States
(12) Patent Application Publication
(10) Pub. No.: US 2008/0225281 A1
(43) Pub. Date: Sep. 18, 2008

(54) Visual inspection apparatus

(75) Inventor: Takahiro Komuro, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OLYMPUS CORPORATION, Tokyo (JP)

(21) Appl. No.: 11/904,421

(22) Filed: Sep. 27, 2007

(30) Foreign Application Priority Data
Sep. 29, 2006 (JP) P2006-268479

(51) Int. Cl. G01N 21/00

(52) U.S. Cl. 356/237.2

(57) ABSTRACT

The present invention is related to a visual inspection apparatus which can inspect a peripheral edge of a wafer with high efficiency. The visual inspection apparatus can make an inspection of any area on the peripheral edge of the wafer by displaying an inspection area specifying screen on a monitor. The inspection area specifying screen includes a display portion for displaying an observation range and an input portion for setting the observation area. The input portion allows one of step, continuity, and point to be selected as an observation type. A recipe is registered depending on a condition set in the above and thus is used to make an inspection.

### CROSS-REFERENCE TO RELATED APPLICATIONS

This application claims priority from Japanese Patent Application No. 2006-268479, filed in the Japanese Patent Office on Sep. 29, 2006, the disclosure of which is incorporated herein by reference.

### BACKGROUND OF THE INVENTION

1. Field of the Invention

The present invention relates to an apparatus for inspecting a visual of a peripheral edge or the like of a substrate such as a wafer.

2. Description of Related Art

In semiconductor fabrication factories or the like, chips or cracks may be formed in the peripheral edges of semiconductor wafers. When such defects exist, they may cause damage to a wafer during manufacture. If a wafer is destroyed, damage occurs such that manufacturing apparatuses must be stopped for a long period of time, etc. Accordingly, a countermeasure has been taken in the recent fabrication factory of inspecting a peripheral edge of a wafer to check for defects such as chips formed during manufacturing processes and recovering the wafer as needed, etc.

For example, an apparatus for automatically inspecting a peripheral edge of a wafer is disclosed in Japanese Unexamined Patent Publication No. 2003-243465. The inspection apparatus conducts an inspection by acquiring an image of the entire peripheral edge in a state where a wafer is placed on a rotating stage and an elastic member comes in contact with a peripheral end surface of the wafer to regulate the position of the wafer. In the vicinity of the peripheral edge of the wafer, a camera for photographing a top surface of the peripheral edge of the wafer, a camera for photographing a side surface of the peripheral edge, and a camera for photographing a bottom surface of the peripheral edge are disposed in the same plane. At the time of photographing the peripheral edge, a notch position of the wafer is specified and then images of the peripheral edge corresponding to one periphery are captured by the cameras while rotating the wafer. The images of the cameras are processed by a photographed data processor and a defect extracting process is automatically performed except for the notch portions.

PCT Japanese Translation Patent Publication No. 2004-518293 discloses that the peripheral edge is photographed at plural positions dividing the peripheral edge at a constant interval for the purpose of checking for the removal of resist on the peripheral edge, instead of continuously photographing the peripheral edge of the wafer. For example, the peripheral edge is photographed six times every 60° in the peripheral direction and the photographed images are analyzed. When a measured value of any one image exceeds a threshold value, it is considered that a failure occurs in the removal of resist.

### SUMMARY OF THE INVENTION

The present invention provides a visual inspection apparatus for making a visual inspection of a peripheral edge of a wafer pursuant to a preset recipe, the visual inspection apparatus including: a wafer holder that holds a wafer so as to be rotatable; a peripheral edge imaging section that acquires an enlarged image of a peripheral edge of the wafer; an inspection area specifying section that enables the setting of information of an inspection position on the peripheral edge of the wafer at the time of setting a recipe; and a control unit that prepares and registers a recipe for making an inspection of the inspection position set by the inspection area specifying section and that controls the wafer holder and the peripheral edge imaging section to make an inspection pursuant to the registered recipe.

### BRIEF DESCRIPTION OF THE DRAWINGS

FIG. 1 is a diagram illustrating a schematic configuration of a visual inspection apparatus according to an embodiment of the invention.

FIG. 2 is a diagram illustrating an arrangement example of cameras of a peripheral edge imaging section.

FIG. 3 is a diagram illustrating an example of a screen display for setting an inspection condition.

FIG. 4 is a diagram illustrating an example of a screen display for specifying an inspection area.

FIG. 5 is a diagram illustrating an arrangement of a robotic a visual inspection apparatus, and a wafer at the time of automatically preparing a recipe using information on portions to be grasped when the wafer is grasped.

### DETAILED DESCRIPTION OF THE INVENTION

### First Embodiment

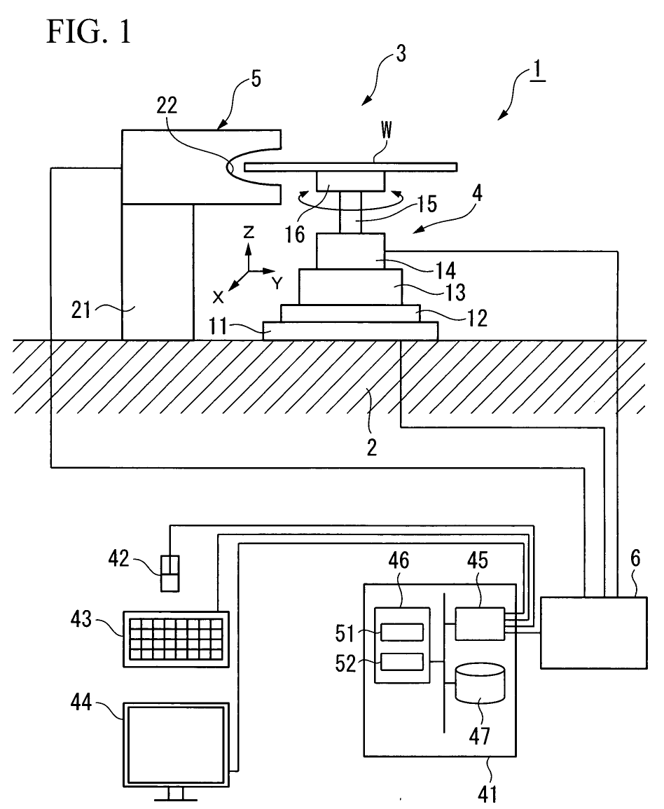

As shown in FIG. 1, a visual inspection apparatus 1 includes a base unit 2 fixed to a frame or the like not shown and an inspection unit 3 mounted an the base unit 2. The inspection unit 3 includes a wafer holder 4 on which a wafer W as an inspection target is placed and a peripheral edge imaging section 5 that is disposed close to the wafer holder 4 so as to acquire an image of a peripheral edge of the wafer W. The wafer holder 4 and the peripheral edge imaging section 5 are controlled by an apparatus control unit 6. A surface inspection section such as a microscope capable of observing the entire surface of the wafer W may be provided in addition to the peripheral edge imaging section 5.

The wafer holder 4 has an X stage 11 fixed to the base unit 2 so as to be movable in a horizontal direction indicated by X in FIG. 1. A Y stage 12 movable in the Y axis that is a horizontal direction perpendicular to the X axis is mounted on the X stage 11. A Z stage 13 movable in the Z direction that is a vertical direction perpendicular to the X and Y directions is mounted on the Y stage 12. Accordingly, the wafer holder 4 can move the wafer W three-dimensionally relative to the peripheral edge imaging section 5. A rotating portion 14 is disposed in the Z stage 13. The rotating portion 14 has a rotation-shaft 15 rotatable about the Z axis. The stages 11 to 13 and the rotation shaft 15 are driven by the use of a servo motor, a ball screw, or a deceleration mechanism. A stepping motor or a linear motor can be used as a driving source. A rotating plate 16 is disposed at the top end of the rotation shaft 15. A suction portion not shown for holding the wafer W by the use of vacuum suction is disposed on the top surface of the rotating plate 16.

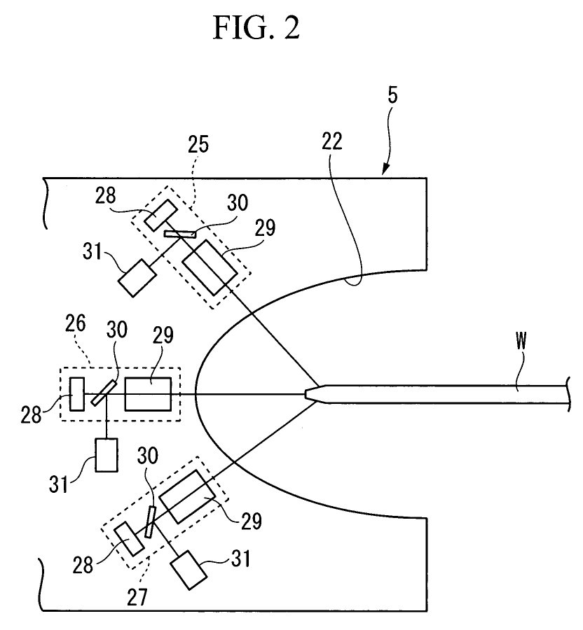

The peripheral edge imaging section 5 is supported by an arm 21 fixed to the base unit 2. The peripheral edge imaging section 5 has a substantially C shape having a concave portion 22 for receiving the peripheral edge of a wafer W in a side view and is provided with cameras for photographing the peripheral edge of the wafer W. An example of a peripheral edge imaging section having three cameras is shown in FIG. 2. The cameras include a first camera 25 for photographing a top surface of the peripheral edge of the wafer W, a second camera 26 for photographing a side surface of the peripheral edge of the wafer W, and a third camera 27 for photographing a bottom surface of the wafer W. Each of the cameras 25 to 27 has an imaging element 28 such as a charge coupled device (CCD) and a zoom lens 29 having a focus function and can constitute a coaxial illumination system using an illuminating device 31 by disposing a half mirror 30 in the optical axis. The number of cameras may be changed to 1, 5, or any number. When only one camera is used, a photographing position may be adjusted by movably supporting the camera or the photographing position may be adjusted by the use of a movable mirror so that a distance from the camera to an observation position on the end surface of the wafer is constant. The illuminating device 31 is not limited to the coaxial illuminating system, but may be singularly or plurally disposed at a position spaced from the cameras 25 to 27. The illuminating device 31 preferably illuminates the peripheral edge so as to observe the peripheral edge in a bright view.

The apparatus control unit 6 shown in FIG. 1 controls the driving of the stages 11 to 13 and the rotating portion 14 of the wafer holder 4, controls the suction vacuuming, adjusts the zoom or focus of the cameras 25 to 27 of the peripheral edge imaging section 5, adjusts the light from the illuminating device 31, and receives image signals from the cameras 25 to 27. For example, the apparatus control unit includes a driver circuit for a motor, a driver circuit for controlling the opening and closing of a vacuuming valve, and the like. The apparatus control unit 6 is also connected to a computer 41.

The computer 41 (control apparatus) is a general-purpose computer to which an input unit such as a mouse 42 or a keyboard 43 and a monitor 44 for displaying various settings or an image of the peripheral edge are connected. The mouse 42, the keyboard 43, and the monitor 44 are interfaces which can be operated by an inspector. The computer 41 has an I/O (Input/Output) unit 45 to which the apparatus control unit 6 or the mouse 42, the keyboard 43, and the monitor 44 are connected, a controller 46, and a memory 47 for the storing data of recipes. The controller 46 includes a CPU (Central Processing Unit) and can be functionally divided into an inspection controller 51 for making an inspection pursuant to a recipe and a recipe register 52 for registering a recipe. The computer 41 may be mounted on the visual inspection apparatus 1 or may be disposed separate from the apparatus. The computer 41 and the apparatus control unit 6 may form one control apparatus.

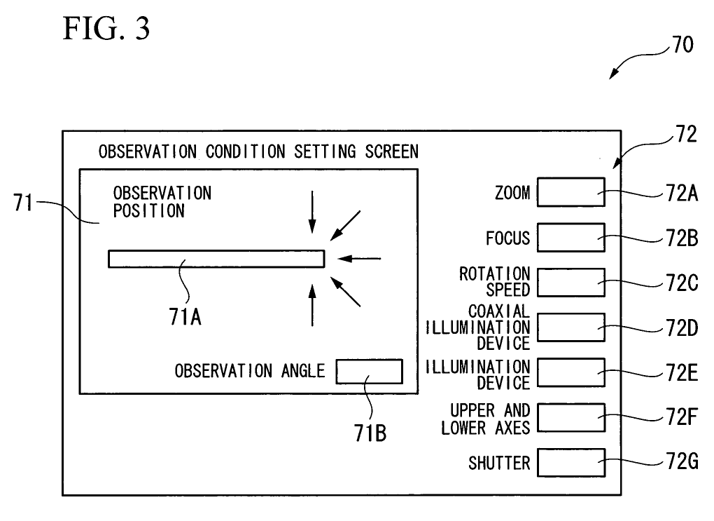

An example of a screen display on the monitor 44 is shown in FIG. 3. The picture on the screen serves as an inspection condition setting section used to set an inspection condition. An inspection condition setup screen 70 displayed as the inspection condition setup section includes an observation position image 71 representing an observation position and a setup portion 72 for inputting an inspection condition in the unit of items. In the observation position image 71, the observation positions of the cameras 25 to 27 are indicated by arrows on the peripheral edge of an image 71A corresponding to the wafer W. Five arrows are marked to observe five directions, but when only three directions can be observed, the arrow of the unobservable direction is not displayed. An input portion 71B for inputting an observation angle is provided and the camera at the angle is selected out of the cameras 25 to 27 by inputting a numerical value to the input portion.

In the setup portion 72, an input portion 72a for inputting magnifications of the cameras 25 to 27 from the screen, an input portion 72B for inputting a focal position, an input portion 72C for inputting a rotation speed of the wafer W, an input portion 72D for inputting light intensity of a coaxial illumination system, an input portion 72E for inputting light intensity another illumination system, an input portion 72F for inputting a position in the Z direction, and an input portion 72G for inputting shutter speeds of the cameras 25 to 27 are arranged and displayed. The input portions 72A to 72G allow numerical values to be input thereto from the keyboard 43.

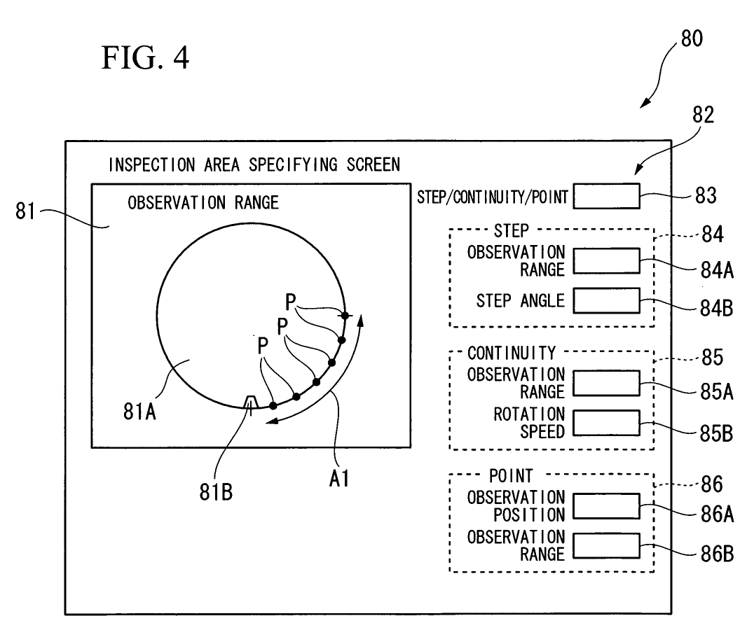

Another example of a screen display on the monitor 44 is shown in FIG. 4. In this embodiment, the picture, the mouse 42, and the keyboard 43 constitute an inspection area specifying section for setting an observation position in the peripheral direction. The inspection area specifying screen 80 displayed on the monitor 44 has a display portion 81 displaying the observation area in the peripheral direction as graphics and an input portion 82 for setting the observation area. A disc-like image 81A corresponding to the wafer W is displayed in the display portion 81 and a cut portion 81B corresponding to a notch of the wafer W is disposed therein. The observation area set by the input portion 82 is overlaid. As indicated by arrow A1 in the peripheral direction in FIG. 4, an area extending by 90° from the notch in the counterclockwise direction is the observation area. As indicated by point P on the outer periphery in the observation area, six positions are photographed at a constant interval of 15°.

The input portion 82 has a selection portion 83 for selecting one out of three photographing types: step, continuity, and point. Step means performing a photographing operation every predetermined step angle in the peripheral direction about the center of the wafer W. The angle is set in the counterclockwise direction on the display portion 81 from the notch position as an angle in the peripheral direction about the center of the wafer. When the wafer has a flat orientation, a graphic corresponding to the flat orientation is displayed on the display portion 81 and an angle is specified on the basis of a degree value. When step is selected by the selection portion 83, an observation range 84A and a step angle 84B are input to a step condition input portion 84. For example, when the observation range is set to the range of 0 to 90° and the step angle is 15°, a recipe for performing a photographing operation every 15° in the range from a starting point of 0° to an end portion of 90° relative to the notch is prepared.

When “continuity” is selected by the selection portion 83, the observation range 85A and the rotation speed 85B are input to a continuity condition input portion 85. For example, when the observation range is set to the range of 0 to 90° and the rotation speed is set to a predetermined value, a recipe for performing a photographing operation continuously in the range extending by 90° from the notch as a starting point is prepared.

When “point” is selected by the selection portion 83, the observation position 86A and the observation range 86B are input to a point condition input portion 86. For example, when the observation range is set to 120° and the observation position is set to 5°, magnifications of the cameras 25 to 27 are set to perform the photographing operation in the range of ±5° about the center at a time and a recipe for photographing the range once extending by 120° from the notch as a starting point in the counterclockwise direction is prepared.

A plurality of inspection positions, that is, observation ranges or points, may be established. For example, when the observation range is setup as a range from 180° to 270° after setup the range from 0 to 90°, two areas can be sequentially inspected.

Next, operations of this embodiment will be described.

First, a recipe is established. The recipe is to define various settings such as zoom, focus, and illuminating devices of the cameras 25 to 27 and the rotation speed of the wafer W so as to satisfactorily acquire an image of the peripheral edge at a predetermined position. The apparatus control unit 6 outputs an instruction signal to the X stage 11 or the like pursuant to the recipe. The settings of the cameras 25 to 27 are set through the inspection condition setup screen 70 shown in FIG. 3 and a photographing type or a photographing position is set through the inspection area specifying screen shown in FIG. 4. Accordingly, the prepared recipe is stored in the memory 47 by the recipe register 52.

At the time of making an inspection, a wafer W is transported by a robotic arm or the like. The wafer W is aligned by an alignment apparatus not shown, the notch position is detected, and then the center of the wafer W is matched with the rotation center of the rotating plate 16 by storing the position of the notch as a reference point. The apparatus control unit 6 controls the suction portion to suction the vicinity of the center on the rear surface of the wafer W in a vacuum manner.

The visual inspection apparatus according to the invention may be combined with an alignment apparatus. By placing the wafer on the rotating plate 16, photographing the wafer with the camera 25 while rotating the wafer, detecting the notch position and the amount of eccentricity, and matching the center of the rotating plate 16 with the center of the wafer W, the particular alignment apparatus is not necessary.

The peripheral edge of the wafer W positioned and held by the wafer holder 4 is inspected pursuant to a recipe registered in advance. The computer 41 reads a recipe from the memory 47 and allows the inspection controller 51 to execute the recipe. While the wafer W is made to rotate at a predetermined speed, the cameras 25 to 27 acquire images of the peripheral edge in the photographing type or photographing position set from the inspection area specifying screen 80 to display the acquired images on the monitor 44. The X, Y, and Z axes of the wafer holder 4 are adjusted so that the image of the peripheral edge is displayed substantially at the center of the monitor 44. Accordingly, an inspector checks the monitor 44 to confirm existence of defects such as chips.

For example, when the step is selected by the selection portion 83 of the inspection area specifying screen 80 and a recipe having an observation range of 0 to 90° and a step angle of 15° is registered, a photographing operation is performed once at a position where the wafer W rotates from the notch position by 15° and the enlarged image thereof is displayed on the monitor 44. The photographing operation is performed again at a position where the wafer further rotates by 15° in the peripheral direction and the enlarged image is displayed on the monitor 44. The photographing operation is performed every rotation by 15° and is stopped at 90°.

When the continuity is selected by the selection portion 83 of the inspection area specifying screen 80 and a recipe having an observation range of 0 to 90° is registered, the cameras 25 to 27 perform the photographing operation and display the photographed picture on the monitor 44 until the wafer W rotates from the notch position by 90°. The photographing operation is stopped at 90°.

When the point is selected by the selection portion 83 of the inspection area specifying screen 80 and a recipe having an observation position of 60° and an observation range of ±5° is registered, the photographing operation is performed once at a position where the wafer W rotates from the notch position by 60° and the photographed picture is displayed on the monitor 44. An image corresponding to the range of ±5° relative to the position of 60° in the peripheral direction is included in the image displayed on the monitor 44. When the photographing operation is ended, the inspection process is stopped.

When two or more inspection positions are specified, the above-mentioned process is repeated. The same photographing type may be repeated or the step and the continuity may be sequentially executed, depending on the details of the registered recipe. When a recipe where combinations of step, continuity, and point are combined is registered, an inspection is made depending on the photographing type and sequence set in the recipe.

When the defectiveness has been checked about the planned inspection positions, the rotation of the wafer W is stopped, the suction is released, and then the wafer W is unloaded by the use of the robotic arm.

In this embodiment, since the positions to be photographed by the cameras 25 to 27 can be specified as a range or points in the peripheral direction, it is not necessary to photograph the entire peripheral edge. When positions at which defective portions such as chips can easily occur can be specified from experiences or the like by collecting past inspection results depending on manufacturing apparatuses or processes and wafer types, it is possible to more precisely check the existence of the slashes by storing the positions in the memory 47 in advance, properly reading and displaying the positions on the monitor 44 at the time of preparing a recipe, and specifying the inspection area on the basis of the displayed picture, thereby reducing the inspection time. Since the amount of data to be processed can be reduced in comparison with a case where an image is acquired from the entire peripheral edge, it is possible to reduce the burden on the computer 41.

Since the observation range or the observation position specified by an inspector is schematically displayed on the inspection area specifying screen 80, it is possible to easily view an image and to reduce the time required for setting the observation range.

### Second Embodiment

A second embodiment of the invention is characterized in that an observation range or position can be automatically set on the basis of data registered in advance. The configuration of the visual inspection apparatus is similar to that of the first embodiment.

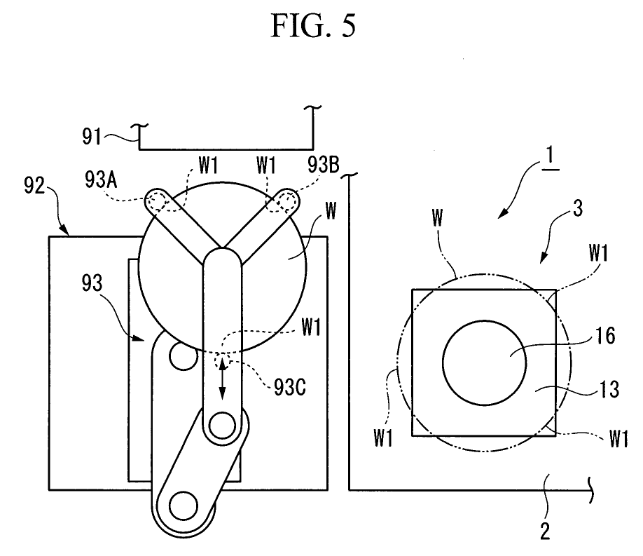

An example of the data registered in advance includes data indicating a position and a range of a wafer W grasped by a robotic arm for transporting the wafer W to the wafer holder 4. For example, as shown in FIG. 5, when a robotic arm 93 of a device 92 for transporting a wafer W from a wafer cassette 91 to the visual inspection apparatus 1 is of such a type to interpose the wafer W between two fixed holders 93A and 93B and one movable holder 93C, three holding portions W1 on which a force acts from the holders 93A to 93C. Since the holding portions W1 are contact portions with the grasping portions and portions on which an external force acts, chips or attachment of particles may easily occur in the holding portions.

The peripheral lengths of the holding portions W1 are values known in advance and determined by the shapes of the holders 93A to 93C of the robotic arm 93. Since the position of the robotic arm 93 and the wafer holder 4 are fixed, the positions of the holding portions W1 are substantially constant, for example, like the positions of the three holding portions W1 in the wafer W indicated by the virtual line in FIG. 5. Accordingly, the positions of the holding portions W1 when the wafer W is held by the wafer holder 4 can be calculated from the information on the holding positions where the robotic arm 93 holds the wafer W and the arrangement of the robotic arm 93 and the wafer holder 4. In this way, data on the calculated positions and sizes of the holding portions W1 are registered in advance in the memory 47 of the computer 41.

The data on the holding portions W1 may be prepared by allowing an inspector to click an edge of a wafer shape on a holding position specifying screen displayed on the monitor 44 and shown in FIG. 4 by the use of the mouse 42 or to input numerical values of angles from the notch by the use of the keyboard 43 while viewing design data or measured data of the holding portions. The computer 42 may overlay CAD data of a design drawing for the holders 93A to 93C of the robotic arm 93 and may allow the inspector to specify the positions of the holding portions W1 while viewing the image on the monitor. A function of automatically detecting the positions of the holding portions W1 may be provided.

The recipe register 52 automatically prepares a recipe on the basis of the data and registers the prepared recipe in the memory 47 so as to inspect only the areas in which the holding portions W1 are disposed. The existence of slashes in the holding portions W1 is checked pursuant to the recipe when making an inspection.

For example, when it is calculated from the shape of the robotic arm 93, the arrangement of the transport device 92, and the like that the holding portions W1 are disposed at three positions (30°, 150°, and 270°) in the counterclockwise direction from a reference position of the wafer holder in an angle in the peripheral direction about the center of the wafer W held by the wafer holder 4, images of the three points are sequentially acquired while rotating the wafer W and are displayed on the monitor 44. The reference position may not be matched with the notch position of the wafer W, and in this case, the calculation may be performed using the notch position as the reference position.

Similarly to the first embodiment, when the visa inspection apparatus is combined with an alignment apparatus, it is possible to detect the notch position and thus to easily detect the holding positions relative to the notch position.

Here, when a layout of the robotic arm 93 or the like is changed, the data registered in the memory 47 is updated. The data may be prepared by another computer or the registered data may be acquired by the use of a known communication unit, instead of being stored in the memory 47.

When an inspection is made in a wafer fabrication line such as a wafer processing apparatus, grasping positions of all the devices grasping the peripheral edge of the wafer W may be registered and the grasping may be conducted at constant angular positions relative to the notch position by constantly calibrating the alignment.

In this embodiment, it is possible to automatically inspect only the positions where the wafer W is held by the robotic arm 93 by the use of the data stored in advance. Compared with the case where the entire peripheral edge is inspected, it is possible to reduce the inspection time. Since the recipe is automatically prepared, the process is simple.

The invention is not limited to the above-mentioned embodiment, but is widely applicable.

For example, the wafer holder 4 is not limited to the configurations of the above-mentioned embodiments, as long as it can move a wafer W in three directions (X, Y, and Z) and rotate the wafer W. Instead of moving the wafer in the X, Y, and Z directions, the peripheral edge imaging section 5 may be mounted on the X stage, the Y stage, and the Z stage so as to move in three directions (X, Y, and Z). A mechanism movable in at least one of the X, Y, and Z directions may be provided in the wafer holder 4 and mechanisms movable in the other two directions may be provided in the peripheral edge imaging section 5. The visual inspection apparatus according to the invention can make an inspection of only a part on the peripheral edge of a wafer. For example, when the diameter of a wafer is about 30 cm, the length of the peripheral edge thereof is about 1 m. In the past, an inspection of the longitudinal area was always made. However, the visual inspection app us can make an inspection of only a desired portion.

Accordingly, since an inspection of only a desired portion on the peripheral edge of a wafer can be made, it is possible to reduce an inspection time. When positions at which chips can easily occur are known from experience or the like, it is possible to reduce the inspection time and also to satisfactorily discover chips by specifying such positions as the inspection area.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A visual inspection apparatus for making a visual inspection of a peripheral edge of a wafer pursuant to a preset recipe, the visual inspection apparatus comprising:
a wafer holder that holds the wafer so as to be rotatable;
a peripheral edge imaging section that acquires an enlarged image of a peripheral edge of the wafer;
an inspection area specifying section that enables the setting of information of an inspection position on the peripheral edge of the wafer at the time of setting a recipe; and
a control unit that prepares and registers a recipe for making an inspection of the inspection position set by the inspection area specifying section and that controls the wafer holder and the peripheral edge imaging section to make an inspection pursuant to the registered recipe.

2. The visual inspection apparatus according to claim 1, wherein the inspection area specifying section allows a starting point and an ending point to be input as an inspection range in an angle in the peripheral direction about the center of the wafer and the angles of the starting point and the ending point are angles relative to a position of a notch of the wafer or an orientation flat.

3. The visual inspection apparatus according to claim 1, wherein the inspection area specifying section can specify an inspection range in angles in the peripheral direction about the center of the wafer and can specify an observation position every predetermined angle in the inspection range.

4. The visual inspection apparatus according to claim 1, wherein the control unit has a function of inputting design data of a transport device that transports the wafer to the wafer holder.

5. The visual inspection apparatus according to claim 4, wherein the inspection area specifying section can specify an inspection area by the use of the design data of the transport device.

6. The visual inspection apparatus according to claim 5, wherein the inspection area specifying section overlay the design data of the transport device at the time of specifying the inspection area.

7. The visual inspection apparatus according to claim 1, wherein the control unit prepares a recipe in which an inspection position on the peripheral edge of the wafer is set on the basis of information on a position at which a transport device for transporting the wafer to the wafer holder holds the wafer.

8. The visual inspection apparatus according to claim 7, wherein the control unit acquires the information on a position, at the transport device holds the wafer, through a communication unit from another control apparatus having an inspection area specifying section.

9. The visual inspection apparatus according to claim 4, wherein the transport device performs its transport operation by grasping the wafer so as to be interposed therebetween.

10. The visual inspection apparatus according to claim 1, further comprising memory that registers a position at which a lots of defects occur as a result of totaling past inspection results and that can read out the information on the position at the time of preparing a recipe.
